(19) United States
(12) Patent Application Publication
(10) Pub. No.: US 2005/0171966 A1
(43) Pub. Date: Aug. 4, 2005

(54) Relational to hierarchical tree data conversion technique

(75) Inventors: Cale T. Rath, Byron, MN (US); David A. Wall, Rochester, MN (US)

Correspondence Address: William J. McGinnis, Jr.;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/767,040

(22) Filed: Jan. 29, 2004

(51) Int. Cl. G06F 17/00

(52) U.S. Cl. 707/101

(57) ABSTRACT

Methods, systems, and articles of manufacture for managing structured data presented in a hierarchical format are provided. The structured data may contain repeating fields or repeating groups of fields. Ordinal values indicating an order in which the repeating fields or field groups occur in the structured data may be created and stored with the structured data in relational tables. Upon retrieval, the ordinal values may be used to reconstruct the structured data with data for the various fields in the original order in the hierarchical format in which it was presented.

### CROSS-REFERENCE TO RELATED APPLICATIONS

The present application is related to commonly-owned U.S. Pat. No. 6,519,603, entitled “Method And System For Organizing An Annotation Structure And For Querying Data And Annotations” and commonly owned, co-pending application Ser. No. 10/600,014, entitled “Universal Annotation Management System”, which are herein incorporated by reference.

### BACKGROUND OF THE INVENTION

1. Field of the Invention

The present invention relates to the field of data entry and retrieval and, more particularly, to a method and system for storing and retrieving structured data in a relational format.

2. Description of the Related Art

Many types of software applications involve the capture of data from users via graphical user interface (GUI) forms. Similar forms may also be used to present data to the users. One example of an application for such forms is an annotation system used to capture descriptive information about data objects in the form of annotations. Virtually any type of data object may be annotated, such as a matrix of data (e.g., a spreadsheet or database table), a text document, or an image. Further, subportions of objects (sub-objects) may be annotated, such as a cell, row, or column in a database table or a section, paragraph, or word in a text document.

An annotation store, typically a database, contains the descriptive information for the annotation, and an indexing scheme is used to map each annotation to the object or the position within the object. An example of such an annotation system is described in the commonly owned, co-pending application Ser. No. 10/600,014, entitled “Universal Annotation Management System”, and incorporated by reference herein in its entirety. According to that annotation system, structured forms (or templates) are provided to collect user annotations of a type that match the object being annotated and, possibly, the role of the user. In other words, annotations for different type data objects may have different fields for capturing different types of information. In this way, detailed, classifiable, and structured annotations can be collected, and later searched in the database.

The forms are generated from corresponding structures which are retrieved when needed, processed for display, and information entered via fields presented in the forms is parsed. The structures are defined by combining various sets of fields and groups of fields. To enable consistency between a potentially large number of structures that are created for the many different types of annotation that may be supported by the annotation system, a set of reusable fields and field groups are provided. These fields and field groups may be combined to generate a wide variety of structures sharing a common set of fields and field groups. A benefit of this approach is that fields and groups are consistent across all structures where they are used, and changes are reflected in all structures using them.

Another benefit is that reusing fields and field groups makes the data easier to query outside of the annotation system. For example, if data for a common concept (or group of related fields) is stored in the same relational table, that data may be easily queried even though data for multiple structures is stored in the table. However, a number of challenges is presented with storing such structured data in a relational format. As an example, when annotation data is returned from a relational database, data from repeating fields may not be returned in the same order as it was entered by a user, because of the way it is retrieved from the database. As a result, when the relational data is reformatted for presentation to a user, data may be displayed in the wrong field. Another challenge is how to store multi-value (repeating) fields in a relational model. A conventional relational model might require a separate record for each repeating field. However, this results in inefficient storage as only the data for repeating fields may change while data for the non-repeating fields in each record is redundant.

Accordingly, there is a need for methods and systems for managing structured data and storing such structured data in a relational format.

### SUMMARY OF THE INVENTION

The present invention generally is directed to methods, systems, and articles of manufacture for managing structured data and storing such structured data in a relational format.

One embodiment provides a method for managing structured data having one or more repeating fields, wherein at least two instances of a repeating field are contained in the structured data. The method generally includes receiving a hierarchical data structure containing the structured data, parsing the structured data to identify the repeating fields, generating an ordinal value for each instance of the repeating fields, each ordinal value indicating an order in which a corresponding instance value of a repeating field occurs in the hierarchical data structure as received, and storing the structured data and ordinal values in one or more relational tables. In some cases, the structured data may contain groups of fields and the methods described herein may be utilized in a similar manner to manage structured data having repeating groups of fields. For example, a group ordinal value may be generated for each instance of a repeating field group, with the group ordinal. indicating an order in which a corresponding instance value of a repeating field group occurs in the hierarchical data structure as received.

Another embodiment provides a computer-readable medium containing an executable component for managing structured data having one or more repeating fields, wherein at least two instances of a repeating field are contained in the structured data. When executed by a processor, the executable component performs operations generally including receiving a hierarchical data structure containing the structured data, parsing the structured data to identify the repeating fields, generating an ordinal value for each instance of the repeating fields, each ordinal value indicating an order in which a corresponding instance value of a repeating field occurs in the hierarchical data structure as received, and storing the structured data and ordinal values in one or more relational tables.

Another embodiment provides a system for managing structured data generally including a set of template structures, each specifying one or more fields (which may be organized as groups of fields), a client component configured to generate interfaces based on the template structures for receiving the structured data and generate a hierarchical data structure containing the structured data, wherein the structured data contains one or more repeating fields (or field groups) with multiple instance values, and a server component. The server component is generally configured to receive the hierarchical data structure from the client component, parse the structured data contained therein, and store the structured data in one or more relational tables along with ordinal values for each instance of the repeating fields, each ordinal value indicating an order in which a corresponding instance value of a repeating field occurs in the hierarchical data structure as received.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is an exemplary computing environment in which embodiments of the present invention may be utilized.

FIG. 2 is a relational view of an annotation system in which embodiments of the present invention may be utilized.

FIGS. 3A-3D are flow charts illustrating exemplary operations for managing structured data in accordance with embodiments of the present invention.

FIG. 4 is an exemplary GUI screen for entering structured data in accordance with one embodiment of the present invention.

FIGS. 5 is an exemplary hierarchical tree structure in accordance with one embodiment of the present invention.

FIGS. 6A-6D are exemplary data structures in accordance with embodiments of the present invention.

### DETAILED DESCRIPTION OF THE PREFERRED EMBODIMENTS

Embodiments of the present invention provide methods, systems, and articles of manufacture that may be used to manage and store structured data in a relational format. The structured data may contain repeating fields or repeating groups of fields. Ordinal values indicating an order in which the repeating fields or field groups occur in the structured data may be created and stored with the structured data in relational tables. Upon retrieval, the ordinal values may be used to reconstruct the structured data with data for the various fields in the original order it was presented. For some embodiments, repeating fields and field groups may be stored with their corresponding ordinal values in separate relational tables with key values linking them back to an owning or parent group.

As used herein, the term structured data generally refers to a any collection of data contained in defined set of fields and/or field groups. To facilitate understanding, annotation data, entered by a user via a structure-based interface, as a specific, but not limiting, example of structured data that may be managed utilizing aspects of the present invention. The term annotation data (or simply annotation) generally refers to any type of descriptive information associated with one or more data objects. Annotations may exist in various forms, including any combination of textual annotations (descriptions, revisions, clarifications, comments, instructions, etc.), graphical annotations (pictures, symbols, etc.), sound clips, etc.

While structured annotation data illustrates one specific, but not limiting, example of structured data that may be managed utilizing aspects of the present invention, it should be understood, however, that aspects of the present invention may more generally be applied in a variety of systems, to manage various types of structured data in various enterprises. For example, aspects of the present invention may be used to manage structured data in travel-related entities (e.g., to manage structured flight and passenger information), educational or healthcare entities (e.g., to manage structured student or patient data), in manufacturing entities (e.g., to manage structured employee, customer, or product inventory data), and various other entities. Systems in each of these type entities may allow users to input and view structured data via graphical user interface (GUI) forms, many of which may share a common set of fields or field groups with other such forms used in the same system.

Further, as used herein, the term user may generally apply to any entity utilizing the annotation system described herein, such as a person (e.g., an individual) interacting with an application program or an application program itself, for example, performing automated tasks. While the following description may often refer to a graphical user interface (GUI) intended to present information to and receive information from a person, it should be understood that in many cases, the same functionality may be provided through a non-graphical user interface, such as a command line and, further, similar information may be exchanged with a non-person user via a programming interface.

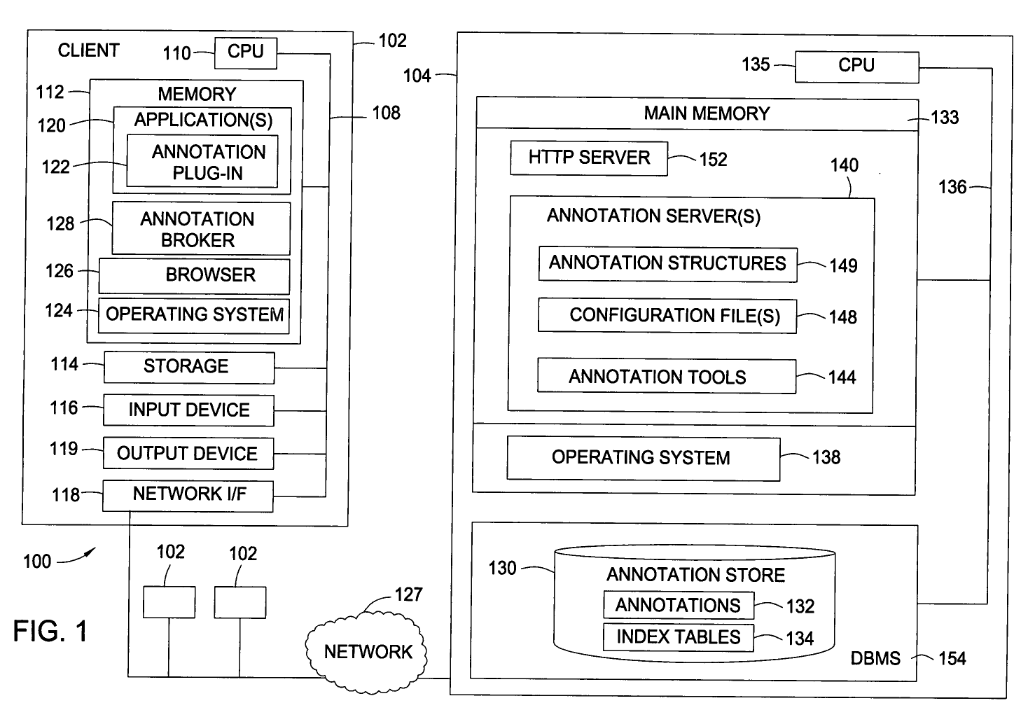

One embodiment of the invention is implemented as a program product for use with a computer system such as, for example, the data processing system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

### An Exemplary Environment

FIG. 1 illustrates an exemplary data processing system 100 in which embodiments of the present invention may be utilized, for example, while exchanging information, captured in the form of annotations, between users collaborating on a project. As illustrated, the system 100 generally includes one or more client computers 102 (e.g., user workstations) generally configured to access annotations 132, via an annotation server 140 (e.g., a software component) running on at least one server computer 104. The client computers 102 and server computer may be connected via a network 127. In general, the network 127 may be any combination of a local area network (LAN), a wide area network (WAN), wireless network, or any other suitable type network, including the Internet. As will be described herein, structured annotation data entered by a user may be sent from the client 102 to the server 104 (over the network 127) to be stored in a relational annotation store 130.

As illustrated, the client computers 102 generally include a Central Processing Unit (CPU) 110 connected via a bus 108 to a memory 112, storage 114, input devices 116, output devices 119, and a network interface device 118. The input devices 116 may be any devices to give input to the client computer 102, such as a mouse, keyboard, keypad, light-pen, touch-screen, track-ball, or speech recognition unit, audio/video player, and the like. The output devices 119 may be any suitable devices to give output to the user, including speakers, various types of display screens, and printers. Although shown separately from the input device 116, the output device 119 and input device 116 could also be integrated (e.g., a display screen with an integrated touch-screen).

The network interface device 118 may be any entry/exit device configured to allow network communications between the client computer 102 and the server computer 104 via the network 127. For example, the network interface device 118 may be a network adapter or other network interface card (NIC). Storage 114 is preferably a Direct Access Storage Device (DASD). Although shown as a single unit, storage 114 may be any combination of fixed and/or removable storage devices, such as fixed disc drives, floppy disc drives, tape drives, removable memory cards, or optical storage. The memory 112 and storage 114 could be part of one virtual address space spanning multiple primary and secondary storage devices.

The memory 112 is preferably a random access memory (RAM) sufficiently large to hold the necessary programming and data structures of the invention. While the memory 112 is shown as a single entity, it should be understood that the memory 112 may in fact comprise a plurality of modules, and that the memory 112 may exist at multiple levels, from high speed registers and caches to lower speed but larger DRAM chips. Illustratively, the memory 112 contains an operating system 124. Examples of suitable operating systems, which may be used to advantage, include Linux and Microsoft's Windows®, as well as any operating systems designed for handheld devices, such as Palm OS®, Windows® CE, and the like. More generally, any operating system supporting the functions disclosed herein may be used.

The memory 112 is also shown containing at least one application 120 (optionally shown with an associated annotation plug-in 122 and an annotation broker 128). The application 120 may be any of a variety of applications used to manipulate (e.g., create, view, and/or edit) data that may be annotated. For example, the application 120 may be a text editor/word processor used to manipulate annotatable documents, a database application or spreadsheet used to manipulate data, a document generator/viewer (such as Adobe's Acrobat® and Acrobat Reader) used to manipulate documents, or data analysis software, such as Decision Site available from Spotfire, Inc., imaging software used to manipulate images, and any other types of applications used to manipulate various types and forms of data.

Some application programs 120 may be configured to communicate with the annotation server 140 directly, for example, via a set of application programming interface (API) functions (not shown) provided for the annotation server 140. As used herein, the term API generally refers to any set of interface functions (e.g., implementing any suitable inter-process protocol) that may be used to communicate between a client computer or process and a server computer or process. Other application programs, however, may communicate with the annotation server 140 via plug-in components 122 and/or the annotation broker 128 (e.g. also via API functions). In other words, annotation capability may be added to an existing application 120 via the plug-in components 122. The plug-in components 122 may, for example, present graphical user interface (GUI) screens to users of applications 120, thus allowing the creation and retrieval of annotations from within the applications used to manipulate the annotated data.

The annotation broker 128 is an optional component and may be implemented as a software component configured to present a standard interface to the Annotation Server 140 from various applications 120, for example, communicating with plug-in components 122 from multiple applications running on the same client computer 102. Hence, the annotation broker 128 may provide a degree of separation between the applications 120 and the annotation server 140, hiding detailed operation of the annotation server 140 and facilitating development of plug-in components 122. In other words, new applications 120 may be supported through the development of plug-in components 122 written in accordance with the annotation broker interface.

Components of the server computer 104 may be physically arranged in a manner similar to those of the client computer 102. For example, the server computer 104 is shown generally comprising a CPU 135, a memory 133, and a storage device 134, coupled to one another by a bus 136, which may all functions as similar components described with reference to the client computer 102. The server computer 104 is generally under the control of an operating system 138 (e.g., IBM OS/400®, UNIX, Microsoft Windows®, and the like) shown residing in memory 133.

As illustrated, the server computer 104 may be configured with the annotation server 140, also shown residing in memory 133. The annotation server 140 provides annotation clients (e.g., running on one or more client computers 102) with access to the annotation store 130, for example, via annotation API functions. In other words, the annotation API functions generally defines the interface between annotation clients and the annotation server 140. As used herein, the term annotation client generally refers to any user interface (or other type front-end logic) of the annotation system that communicates with the annotation server to manipulate (e.g., create, update, read and query) annotation data. Examples of annotation clients include applications 120 communicating with the annotation server 140 (directly, or via plug-in components 122) and an annotation browser 126.

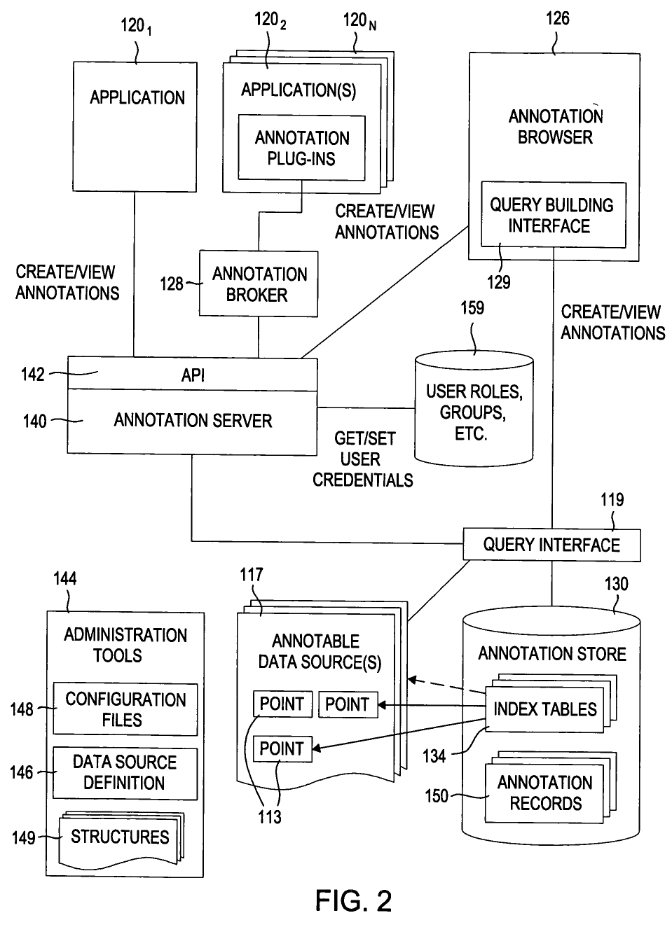

FIG. 2 illustrates a relational view of the annotation server 140 and various other components of the annotation system, in accordance with one embodiment of the present invention. As previously described, one or more applications 120 (e.g., residing on one or more client computers 102) may communicate with the annotation server 140 either directly (e.g., application 120₁) or via the annotation plug-ins 122 and/or annotation broker 128 (e.g., applications 120₂-120_{N}), to create or view annotations for data object manipulated by the applications 120. For some embodiments, components of the annotation system (the annotation server 140, annotation plug-ins 122, annotation broker 128, and annotation browser 126) may be similar in operation to those described in the commonly owned, co-pending application Ser. No. 10/600,014, entitled “Universal Annotation Management System.”

As illustrated, the annotation server 140 may issue queries against the annotation store 130 via a query interface 119. The annotation broker 128 may serve as an interface between annotation plug-ins 122 for multiple applications and the annotation server 140. For example, the annotation broker 128 may manage messages sent to and from multiple annotation plug-ins and the annotation server (e.g., providing mediation between multiple plug-in components 122 trying to access the annotation server 140 simultaneously). For some embodiments, the annotation broker 128 may be implemented as a Windows Component Object Model (COM) server that provides a standard interface and facilitates access to the annotation server 140 for annotation plug-ins 122 for Windows applications (e.g., Microsoft Internet Explorer, Microsoft Word, Microsoft Excel, Adobe Acrobat, Spotfire, and other Windows applications). In other words, by providing a standard interface to the annotation server 140, the annotation broker 128 may facilitate extension of the annotation system to support new applications 120 through the development of plug-in components written in accordance with its interface.

As illustrated, an annotation browser 126 may allow the creation and viewing application data and annotations, independently of any of the applications 120. For some embodiments, the annotation browser 126 may provide a generalized web-based user interface for viewing structured data content (e.g. application source data that can be accessed directly through queries via the query interface 119), and for creating and viewing annotations on it. As will be described in greater detail below, for some embodiments, the annotation browser may provide an interface allowing a user to simultaneous query data sources 117 and associated annotations.

For some embodiments, in order to identify annotated data object(s), an index, or set of indexes, that may be used to identify the corresponding annotated data object(s) may be stored with the annotation data. As illustrated, an index obtained from an annotation record may be used to retrieve information from one or more index tables 134 that may be used to identify the annotated data object or sub-objects, commonly referred to as annotated points 113.

For some embodiments, the annotation server 140, and various related components, may be configured via a set of administrative tools 144. For example, the tools 144 may be used to generate configuration data 145 accessed by the annotation server 140. As illustrated, the configuration data 145 may include various configuration files 148, a data source definition file 148 which may contain various information, such as identification of a set of annotation structures (or templates) 149 for use in displaying and collecting annotation data, the various annotatable data source types and indexing thereof, the roles in which users may operate, and other defining information which may affect operation of the annotation server 140.

The annotation structures 149 may contain a set of fields and groups of fields that determine what data is stored with the annotation and what data is presented to a user viewing the annotation, for example, based on the user's role and/or a type of object being annotated. Interfaces, such as graphical user interfaces (GUIs) may be generated, based on the annotation structures to receive, as user input, structured annotation data. For some embodiments, structured annotation data received via such GUIs may be sent to the server 104 in a hierarchical format, such as an extensible markup language (XML) tree structure. To facilitate storage and searching, however, the server 104 may store the structured data in the annotation store 130 in a relational format.

### Storing Structured Data in a Relational Format

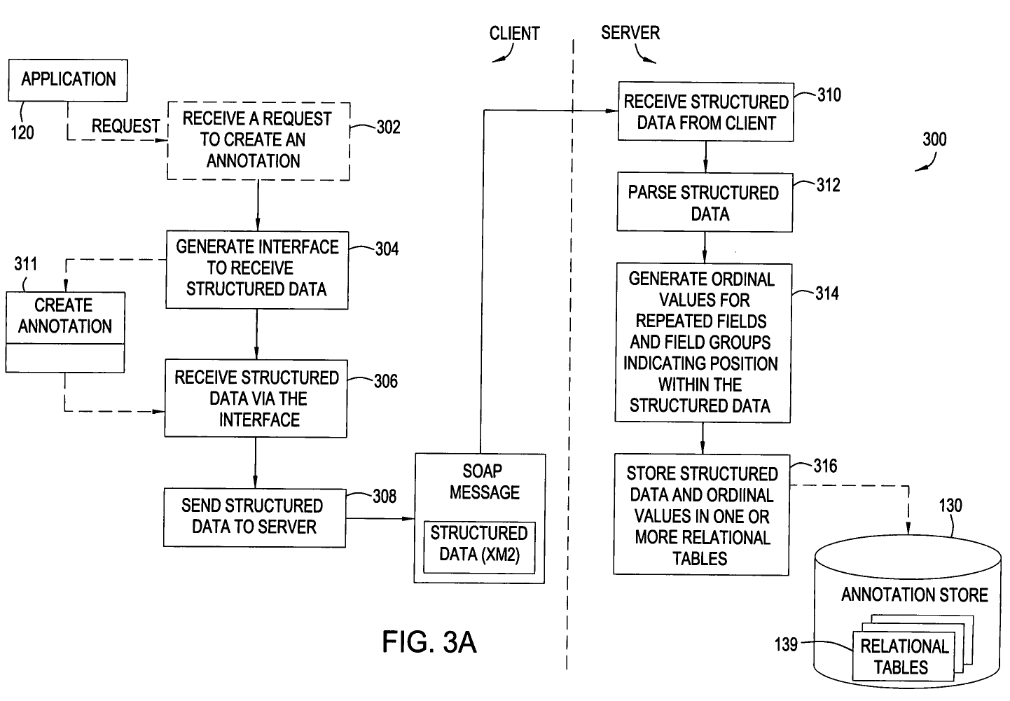

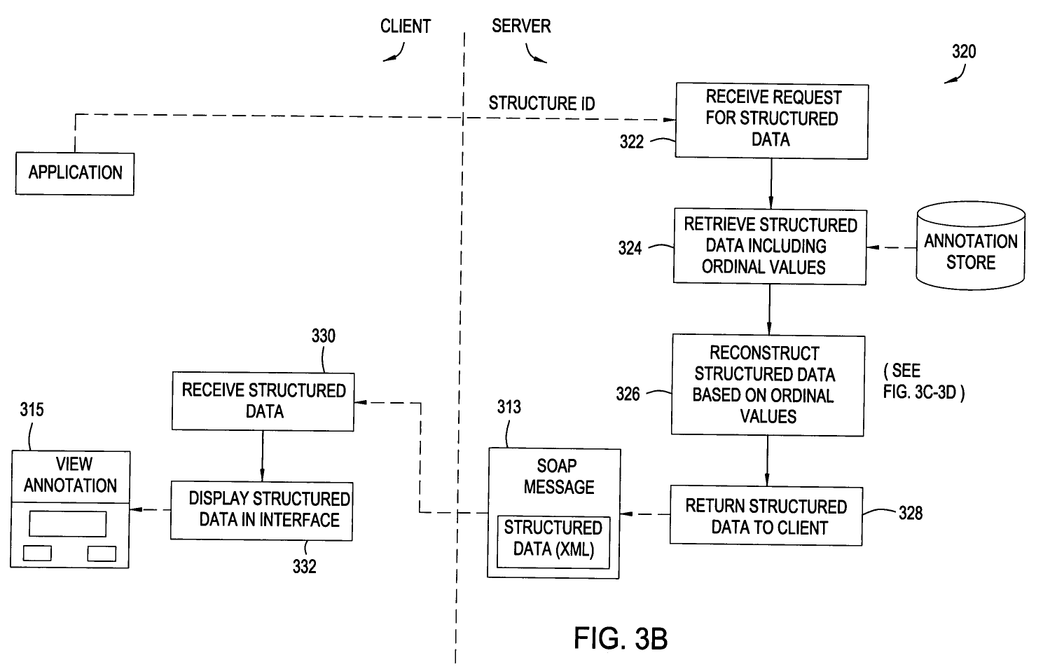

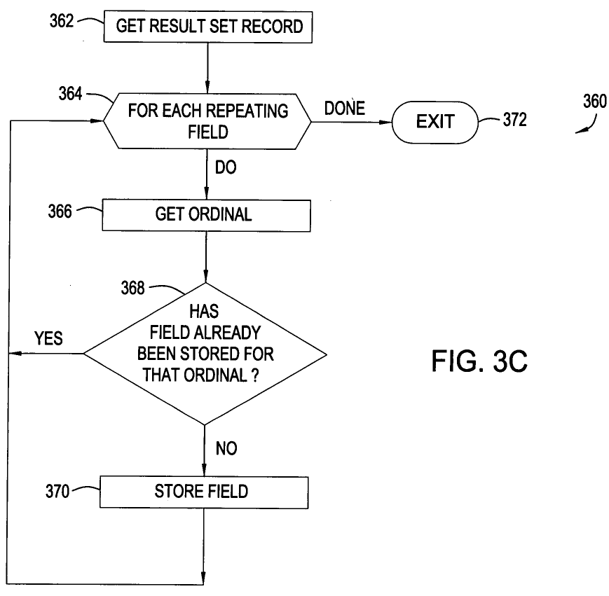

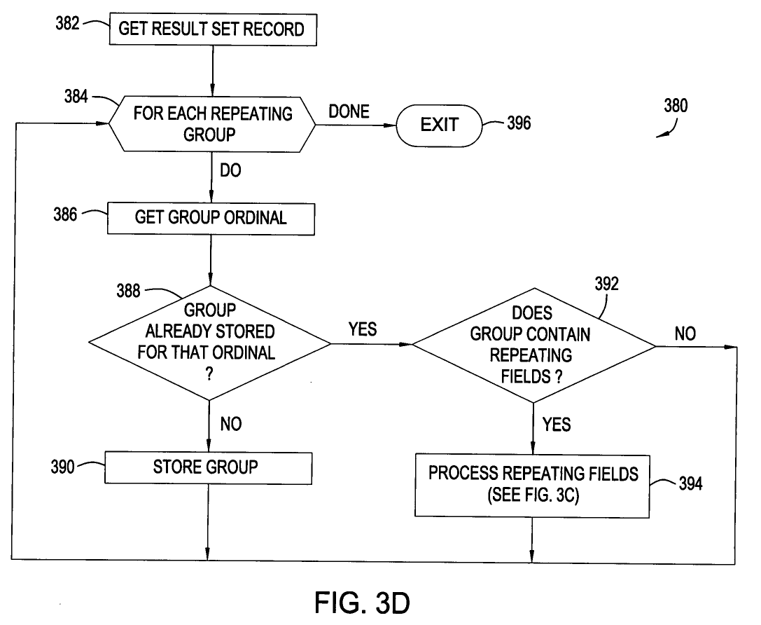

FIGS. 3A-3D are flow diagrams of exemplary operations for managing structured data. For example, FIG. 3A illustrates exemplary operations 300 for creating structured data, such as structured annotation data, and storing such data in a relational format. The operations 300 illustratively begin at step 302, by receiving a request (e.g., from an application 120) to create an annotation for some type data object. At step 304, an interface is generated to receive structured data and, at step 306, structured data is received via the interface. For example, a GUI screen 311 for creating an annotation may be generated based on an annotation structure associated with the data object to be annotated and/or a role of a user creating the annotation.

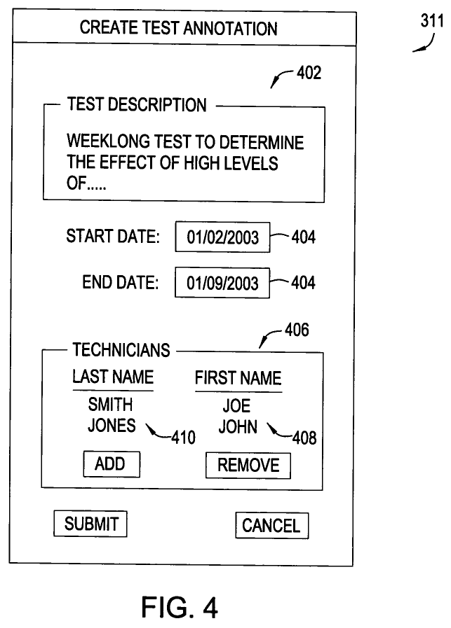

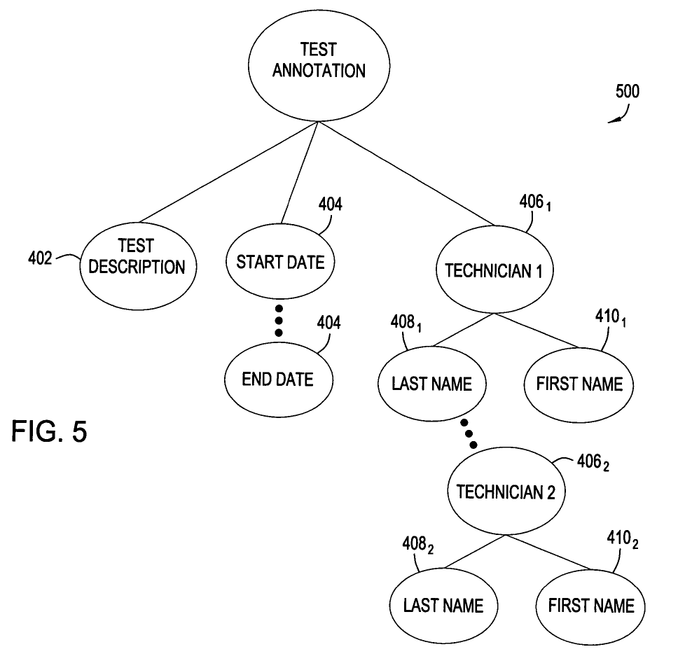

FIG. 4 illustrates an example of the GUI screen 311 for entering annotation data for a test. As illustrated, the GUI screen 311 may allow a user to input structured data in the form of a test description field 402, start and end date fields 404, technician field groups 406 having last name and first name fields 408 and 410, respectively. The date fields 404 may be considered repeating fields (e.g., different instances of the same type and format of data). In this example, the repeating fields may also be referred to as “shared” fields as they are shared between two different data objects (start and end dates). The technician groups 406 may be considered repeating groups, with a different group for each technician listed. As illustrated in FIG. 5, structured data received via the interface 311 may be stored in a hierarchical tree structure 500.

Returning to FIG. 3A, at step 308, structured data is sent to the server, using any suitable mechanism. For example, the structured data may be sent to the server as a hierarchical tree structure (such as that shown in FIG. 5) in XML format within a Simple Object Access Protocol (SOAP) message 313, possibly from the annotation broker 128 to the annotation server 140 (shown in FIGS. 1-2). SOAP messages are just one example of a suitable messaging mechanism that may be utilized. At step 310, the server receives the structured data from the client and parses the structured data at step 312. For example, the server may parse the structured data to identify fields and field groups in an effort to “flatten out” the structured data for storage in the relational annotation store 130.

As previously described, one challenge when storing structured data in relational tables is how to ensure the original order of data from repeating fields and field groups is maintained upon retrieval. For example, if the order of the repeating fields 404 shown in FIGS. 4 and 5 are not maintained, the start and end dates may be reversed when the illustrated test annotation data is retrieved and displayed. To allow the original order to be maintained upon retrieval, at step 314, ordinal values indicating the position of corresponding repeated fields and/or field groups within the structured data are generated. At step 316, the structured data and ordinal values are stored in one or more relational tables (e.g., relational tables 139 in the annotation store 130).

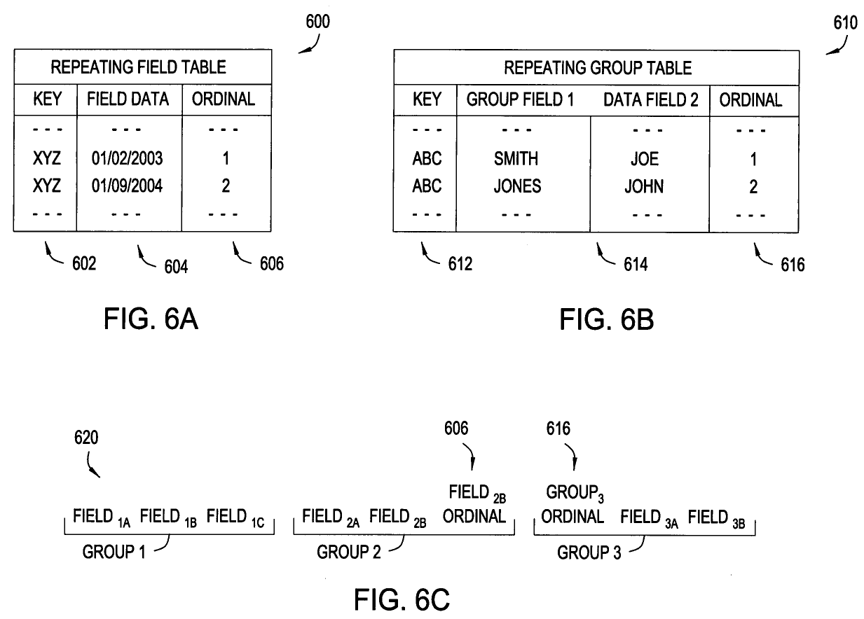

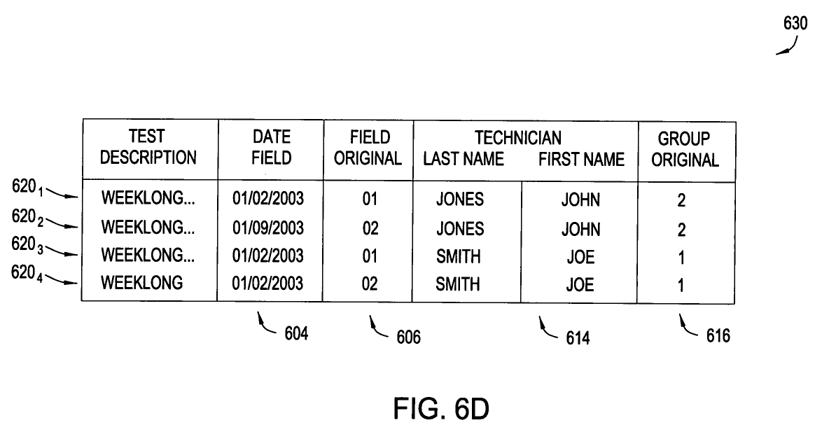

For some embodiments, data from repeating fields may be stored in a separate table. FIG. 6A illustrates one embodiment of a repeating field table 600 which contains three columns: a key value 602, the field data 604, and the ordinal value 606. As illustrated, a row is added for each repeating field item in the structured data. The ordinal value is used to retain the order of the values in the fields. For example, in the illustrated example, the start date comes first and, thus, has an ordinal value of 1 while the end date comes next and, thus, has an ordinal value of 2. The key field is used to link the data in the repeating field table 600 back to the owning group, and a particular instance of the owning group and may be any suitable type data type, such as a group ID or global unique ID. As illustrated in FIG. 6B, data from repeating field groups may be managed in much the same way as data from repeating fields, utilizing a repeating group table 610. In addition to the data for each field group 614, a key value 612 (e.g., linking the field group back to a parent group or annotation), and a group ordinal value 616 are stored.

Those skilled in the art will recognize that storing structured data as described above, will provide advantage in many applications that utilize structured data, regardless of whether or not repeating fields or field groups exist in the structured data. For example, in a number of different type systems (e.g., annotation systems, patient, employee, or customer database systems, flight reservation systems, or any other type of systems that manipulate structured data), different types of forms may share a common group of fields (e.g., personal information as name and address field groups, test result fields, salary-related field groups, etc.). Ideally, data for the common group of fields would be stored in the same location so it can be easily queried (independent of the particular form used to enter the data or if the common data repeats or not). By storing the group data for a particular set of data in a separate table and using keys to correlate with the particular field data stored in separate tables (as shown in FIGS. 6A-6B), the data for the common group of fields is efficiently stored and may be easily be queried.

FIG. 3B illustrates exemplary operations 320 that may be performed by the client and server to retrieve structured data stored in a relational format and reassemble the structured data into a hierarchical format. The repeating field and group ordinal values stored with the structured data may be used to ensure data from repeating fields groups are reassembled in proper locations in the hierarchical data structure, so the structured data is presented in the expected order.

The operations 320 begin, at step 322, by receiving a request for structured data. For example, the annotation server 140 may receive a request from a user of an application 120 to display structured annotation data for a data object being viewed in the application 120. At step 324, the structured data is retrieved (in relational format), including the ordinal values. At step 326, the structured data is reconstructed (in hierarchical format), based on the ordinal values. In other words, as described below with reference to FIGS. 3C and 3D, the ordinal values are used to determine the position of data from repeating fields and groups within the hierarchical structure to be returned to the requesting entity. At step 328, the structured data is returned to the client, for example, again as XML format in a SOAP message 313. At step 330, the client receives the data structure and, at step 322, displays the structured data in an interface (e.g., a View Annotations GUI 315).

### Reassembling Structured Data Using Ordinal Values

FIGS. 3C and 3D illustrate exemplary operations 360 and 380, respectively, that may be performed to reassemble the structured data in the original hierarchical format in which it was received, using the field and group ordinals to locate data from repeating fields and groups in their proper order. The operations 360 and 380 may be described with reference to FIGS. 6C and 6D which illustrate an exemplary generic result record 620 and an exemplary results set 630, respectively. It is assumed that a results set, such as the results set 630, containing the structured data in relational format has already been retrieved (e.g., by operation 324 of FIG. 3B).

The operations 360 begin, at step 362, by obtaining a results set record. As illustrated in FIG. 6C, a result set record 620 will typically include groups of one or more fields arranged from left to right. As illustrated, a repeating field (such as FIELD2B) may be followed by the corresponding ordinal value 606 for the instance data for that field in the record 620. Illustratively, if a field group repeats, the corresponding group ordinal value 616 may be included as the first field in that field group.

At step 364, a loop of operations (366-370) is entered, to be performed for each repeating field in the record. At step 366, the corresponding field ordinal is checked. If (data from) a field has already been stored for that ordinal value, as determined at step 368, (data from) that field is not stored, as that data has already stored when processing a previous record. For example, referring to FIG. 6D, when the repeating date field 604 (having an ordinal value 606 of “1” is encountered when processing record 620₃, the corresponding data (e.g., the start date “Jan. 2, 2003”) has already been stored (e.g., when processing previous record 620₁). If data from the repeating field having that ordinal has not already been stored, data from that field is stored, at step 320. For example, when the repeating date field 604 (having an ordinal value 606 of 2) is encountered when processing record 620₂, the corresponding data (e.g., the end date “Jan. 9, 2003”) has not already been stored. Once each repeating field has been processed, the operations 360 are exited, at step 372.

As illustrated in FIG. 3D, data from repeating field groups may be processed in a similar manner to (single) repeating fields. The exemplary operations 380 of FIG. 3D begin, at step 382, by obtaining a results set record. At step 384, a loop of operations (386-394) is entered, to be performed for each repeating field group in the record. At step 386, the corresponding group ordinal is checked. If (data from) a field group has not yet been stored for that group ordinal value, as determined at step 368, data from that group is stored, at step 390.

On the other hand, if (data from) a field group has already been stored for that group ordinal value, data from the current field group is not stored unless it contains repeating fields (the repeating field group 614 in the simple results set illustrated in FIG. 6D does not contain repeating fields). In other words, if the field group has repeating fields, the results set 630 will have multiple records with the field group having the same ordinal, but with potentially different values for the repeating fields (with different field ordinal values). Therefore, if the current field group does contain repeating fields, as determined at step 392, the repeating fields are processed, at step 394 (e.g., as described above with reference to FIG. 3C).

Once each of the repeating groups for a current record are processed, the operations are exited, at step 396. The operations 360 and 380 may be repeated for each record in the results set, for example, to generate a set of template structures temporarily storing field and group values. These temporary structures may then be used to populate the hierarchical data structure returned to the client. Further, while the operations 360 and 380 are shown in separate flow diagrams, it should be understood that the illustrated operations may actually be performed together, for example, to process repeating fields and field groups for each record in the results set.

While the examples described above illustrated the use of ordinals in determining the order in which repeating fields or field groups were originally presented, ordinal values may also be used to facilitate parsing data. For some embodiments, repeating fields or field groups may be preconfigured in structured data so that an ordinal will always exist, even for a field or field group that does not repeat (e.g., a field or field group that exists only once in the structured data). The ordinal value for a non-repeating field or field group may simply be the same as that+ used to indicate the first member of a repeating set (e.g., “0” or “1”). The inclusion of ordinal values regardless of whether a field or field group repeats may facilitate parsing the structured data. For example, if the same field ordinal value repeats within a group, another field also repeats within the same group. Similarly, if a group ordinal value repeats, it must be noted again that at least one field within that group must also repeat.

### Conclusion

Embodiments of the present invention facilitate the storage and retrieval of structured data, providing advantages of both hierarchical and relational data formats. For example, upon entry, the structured data may be received and sent to a server in a hierarchical format, allowing the use of standard and efficient messaging mechanisms, such as SOAP messaging. Upon receipt by the server, the structured data may be transformed form the hierarchical format to a relational format (“flattened out”) allowing the user of readily available relational storage techniques, which may facilitate searching the structured data. Ordinal values indicating the position of data from repeating fields and field groups may be stored in relational tables with the corresponding data. Upon request, the structured data may be retrieved, reassembled into the hierarchical format, using the ordinal values to locate data from the repeating fields and groups in the (original) proper position, and sent back to the requesting client for display.

As previously described, embodiments of the present invention have been described with reference to structured annotation data as a specific, but not limiting example of a type of structured data that may be managed utilizing aspects of the present invention. However, those skilled in the art will recognize that aspects of the present invention may be applied in any type system where structured data is handed, particularly various template based-input systems.

While the foregoing is directed to embodiments of the present invention, other and further embodiments of the invention may be devised without departing from the basic scope thereof, and the scope thereof is determined by the claims that follow.

1. A method for managing structured data having one or more repeating fields, wherein at least two instances of a repeating field are contained in the structured data, comprising:
receiving a hierarchical data structure containing the structured data;
parsing the structured data to identify the repeating fields;
generating an ordinal value for each instance of the repeating fields, each ordinal value indicating an order in which a corresponding instance of a repeating field occurs in the hierarchical data structure as received; and
storing the structured data and ordinal values in one or more relational tables.

2. The method of claim 1, wherein storing the structured data and ordinal values in one or more relational tables comprises storing instance data from a repeating field in a common relational table.

3. The method of claim 2, wherein the common relational table has at least a column for the instance data, a column for corresponding ordinal values, and a column for a key value to identify a data structure associated with the repeating field.

4. The method of claim 1, wherein the structured data contains at least one repeating group of one or more fields, and the method comprises generating a group ordinal value for each instance of the repeating group of fields, each ordinal value indicating an order in which a corresponding instance value of the repeating group of fields occurs in the structured data as received.

5. The method of claim 4, wherein the at least one repeating group contains at least one of the repeating fields.

6. The method of claim 1, wherein receiving the structured data in a hierarchical format comprises receiving the structured data in a hierarchical format as a Simple Object Access Protocol (SOAP) message.

7. The method of claim 1, wherein the structured data is received as input via an interface generated based on a template structure defined by one or more fields or groups of fields.

8. The method of claim 7, wherein:
the structured data is annotation data related to an annotated data object; and
the template structure is selected based, at least in part, on the annotated data object.

9. The method of claim 1, further comprising:
receiving a request for the structured data;
retrieving the structured data and ordinal values from the one or more relational tables;
assembling the structured data in a hierarchical data structure based on the hierarchical data structure in which it was received, with a position of instance values of repeated fields within the hierarchical data structure determined by corresponding ordinal values; and
returning the assembled hierarchical data structure.

10. A computer-readable medium containing an executable component for managing structured data having one or more repeating fields, wherein at least two instances of a repeating field are contained in the structured data which, when executed by a processor, performs operations comprising:
receiving a hierarchical data structure containing the structured data;
parsing the structured data to identify the repeating fields;
generating an ordinal value for each instance of the repeating fields, each ordinal value indicating an order in which a corresponding instance of a repeating field occurs in the hierarchical data structure as received; and
storing the structured data and ordinal values in one or more relational tables.

11. The computer-readable medium of claim 10, wherein storing the structured data and ordinal values in one or more relational tables comprises storing instance data from a repeating field in a common relational table.

12. The computer-readable medium of claim 11, wherein the common relational table has at least a column for the instance data, a column for corresponding ordinal values, and a column for a key value to identify a data structure associated with the repeating field.

13. The computer-readable medium of claim 10, wherein the structured data contains at least one repeating group of one or more fields, and the method comprises generating a group ordinal value for each instance of the repeating group of fields, each ordinal value indicating an order in which a corresponding instance value of the repeating group of fields occurs in the structured data as received.

14. The computer-readable medium of claim 10, wherein the operations further comprise:
receiving a request for the structured data;
retrieving the structured data and ordinal values from the one or more relational tables;
assembling the structured data in a hierarchical data structure based on the hierarchical data structure in which it was received, with a position of instance values of repeated fields within the hierarchical data structure determined by corresponding ordinal values; and
returning the assembled hierarchical data structure.

15. A system for managing structured data, comprising:
a set of template structures, each specifying one or more fields;
a client component configured to generate interfaces based on the template structures for receiving the structured data and generate a hierarchical data structure containing the structured data, wherein the structured data contains one or more repeating fields with multiple instance values; and
a server component configured to receive the hierarchical data structure from the client component, parse the structured data contained therein, and store the structured data in one or more relational tables with ordinal values for each instance of the repeating fields, wherein each ordinal value indicates an order in which a corresponding instance value of a repeating field occurs in the hierarchical data structure as received.

16. The system of claim 15, wherein the one or more relational tables comprises a common relation table for storing instance data from a repeating field.

17. The system of claim 16, wherein the common relational table has at least a column for the instance data, a column for corresponding ordinal values, and a column for a key value to identify a data structure associated with the repeating field.

18. The system of claim 15, wherein the structured data contains at least one repeating group of one or more fields, and the method comprises generating a group ordinal value for each instance of the repeating group of fields, each ordinal value indicating an order in which a corresponding instance value of the repeating group of fields occurs in the structured data as received.

19. The system of claim 15, wherein the server component is further configured to:
receive a request for the structured data from the client component;
retrieve the structured data and ordinal values from the one or more relational tables;
assemble the structured data in a hierarchical data structure based on the hierarchical data structure in which it was received, with a position of instance values of repeated fields within the hierarchical data structure determined by corresponding ordinal values; and
return the assembled hierarchical data structure to the client component.

20. The system of claim 15, wherein:
the structured data is annotation data related to an annotated data object; and
the structured data is received via an interface generated based on a template structure selected, at least in part, based on the annotated data object.
